(19) United States
(12) Patent Application Publication
(10) Pub. No.: US 2011/0125432 A1
(43) Pub. Date: May 26, 2011

(54) REMOTE MONITORING OF DEVICE OPERATION BY TRACKING ITS POWER CONSUMPTION

(75) Inventors: Itzhak POMERANTZ, Kfar Saba (IL); Itzhak BINYAMINI, Ramat Hasharon (IL)

(73) Assignee: AFEKA TEL AVIV ACADEMIC COLLEGE OF ENGINEERING, Tel Aviv (IL)

(21) Appl. No.: 13/015,615

(22) Filed: Jan. 28, 2011

Related U.S. Application Data
(63) Continuation-in-part of application No. 12/172,235, filed on Jul. 13, 2008.

(51) Int. Cl. G01R 21/133

(52) U.S. Cl. 702/62

(57) ABSTRACT

Monitoring devices by following and analyzing local current measurements and communicating the data over the power line. Various operation characteristics are extracted from the measurements, such as device profiles, operational status, various deficiencies and user related parameters. Current consumption profiles are derived from the accumulating data, and compared to previous patterns. The monitoring allows controlling operation of the devices, estimating their physical location and communicating messages from the devices regarding e.g. software status, by deliberate operation of the device to generate predefined current use patterns.

### CROSS REFERENCE TO RELATED APPLICATIONS

This application is a Continuation In Part of U.S. patent application Ser. No. 12/172,235 filed on Jul. 13, 2008, which is incorporated herein by reference, and claims the benefit thereof in respect to the common subject matter.

### BACKGROUND

1. Technical Field

The present invention relates to the field of monitoring, and more particularly, to monitoring of device operation.

2. Discussion of Related Art

Bauer et al. “Recognizing the Use-Mode of Kitchen Appliances from Their Current Consumption” in Smart sensing and context, Lecture Notes in Computer Science, 2009, Volume 5741/2009, 163-176 (DOI: 10.1007/978-3-642-04471-7_{—}13) and Berges et al. “Enhancing Electricity Audits in Residential Buildings with Nonintrusive Load Monitoring”, Journal of Industrial Ecology, Special Issue: Environmental Applications of Information & Communication Technology. Volume 14, Issue 5, pages 844-858, October 2010, both incorporated herein by reference in their entirety, disclose systems for monitoring instrument loads.

### BRIEF SUMMARY

Embodiments of the present invention provide A system for monitoring a plurality of devices, comprising: a control unit; and associated with each device: a current meter arranged to measure a current used by the device; and a PLC unit arranged to send a device identifier and data relating to the current measurements to the control unit over power line communication (PLC), wherein the control unit is arranged to analyze the current measurements and derive device operation characteristics therefrom.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a system for monitoring a plurality of devices, according to some embodiments of the invention;

FIGS. 2 and 3 are examples for current measurements and the information derived from them, according to some embodiments of the invention;

FIG. 4 is a high level flowchart illustrating a method of monitoring devices according to some embodiments of the invention; and

FIG. 5 illustrates a method for controlling a usage of objects, according to an embodiment of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

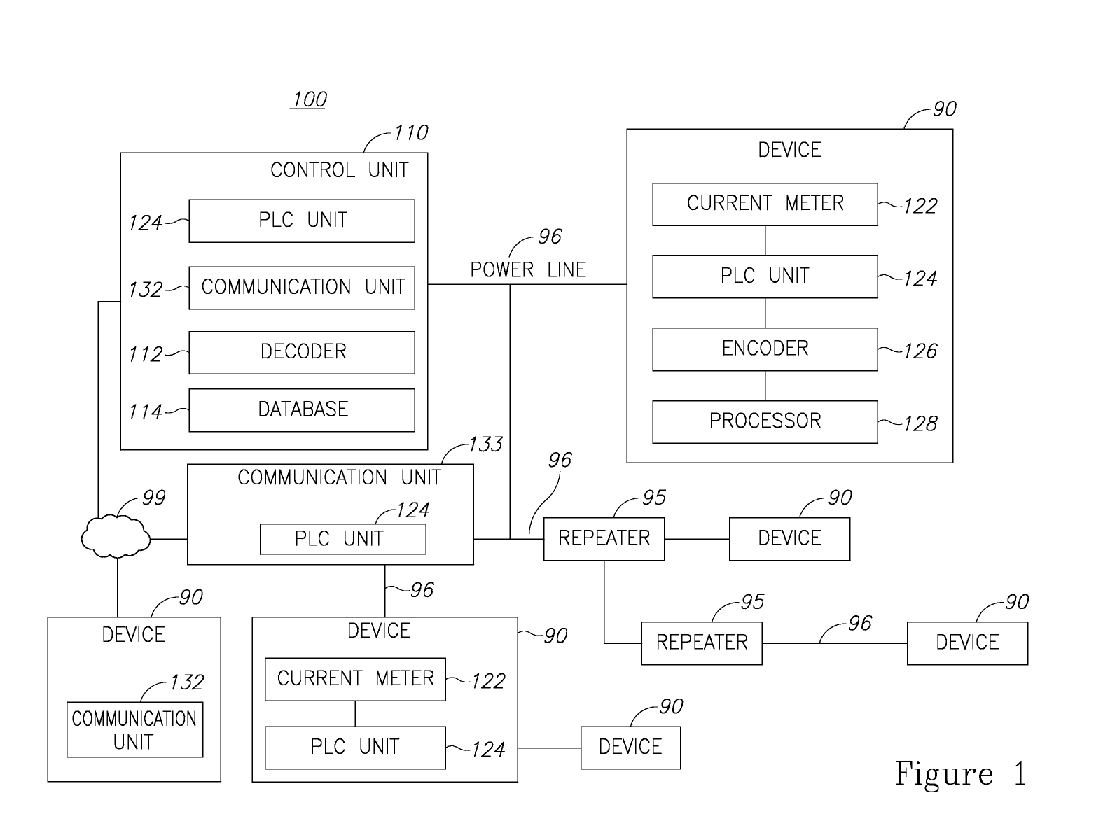

FIG. 1 is a high level schematic block diagram of a system 100 for monitoring a plurality of devices 90 according to some embodiments of the invention. System 100 comprises a control unit 110 connected over power line 96 to devices 90, and current meters 122 and PLC units 124 associated with each device 90. Current meters 122 and PLC units 124 may be integrated within devices 90 or connected to devices 90 internally or externally.

Current meter 122 is arranged to measure a current used by device 90 and PLC unit 124 (e.g. a PLC modem) is arranged to send a device identifier and data relating to the current measurements to control unit 110 over power line communication (PLC). Control unit 110 is arranged to analyze the current measurements and derive device operation characteristics therefrom.

Device (90) operation characteristics may comprise characteristics relating to device profile, characteristics relating to momentary device performance, as well as characteristics relating to defects and malfunction of device 90. Device operation characteristics may comprise for example a device type, an operational state of device 90, a deterioration in device operation, a device malfunction, an improper operation of device 90, a loading status of device 90, and an cumulative usage time of device 90.

Device operation characteristics may comprise a current consumption profile of each device 90 at a specified temporal resolution, or as indications of specified state or changes between states of device 90. Control unit 110 may be further arranged to generate statistical data from obtained current measurements and use the statistical data as a basis for comparison for future measurements. Control unit 110 may store the statistical data in a database 114.

For example, system 100 may detect damaged contacts in device 90 by detecting a reduction in current consumption of device 90, system 100 may identify loaded devices by comparing their current consumption with a given maximal current consumption, and system 100 may identify devices 90 in their initialization stages by detecting a specified current increase during a specified period. System 100 may further discriminate active from idle devices 90 according to specified ranges of current measurements. System 100 may identify improper operation of device 90 by identifying unexpected changes in current measurements.

A device type may be derived from typical current consumption data in relation to statistical data, the operational state of device 90 (on, off, standby, rotation, stage of operation, active components etc.) may be derived in relation to earlier operation patterns. A deterioration in device operation may be detected in relation to earlier data. Improper operation of device 90 may be detected in relation to given criteria or specifications.

The data relating to the current measurements may comprise various derivatives of the current measurements, that are usable to reduce the necessary communication bandwidth. Such derivatives may comprise current idle consumption, current peaks, current drops, and current derivatives. As the PLC network bandwidth is limited and is shared with all devices 90, it may not allow to send the current measurements in high sampling rate. Therefore, the data relating to the current measurements may only comprise the most relevant data (for the derivation of the device operation characteristics), possibly as tags.

At least one of devices 90 may further comprise a processor 128 arranged to derive the data relating to the current measurements from the current measurements to comprise operation relevant data, such that the data relating to the current measurements has a smaller size than the current measurements, selected to allow communication of the data over PLC during a specified threshold period.

Control unit 110 may be further arranged to prevent supply of power to a device 90 upon receiving specified current measurements therefrom, according to specified criteria. For example, devices 90 that are being improperly operated may be disconnected and checked, or user identification may be controlled.

System 100 may further comprising a plurality of repeaters 95 arranged to enhance PLC signals from PLC units 124 to control unit 110. Each repeater 95 has an identifier and a physical location, and is arranged to add to the enhanced PLC signals its identifier. Control unit 110 is further arranged to estimate from the repeater identifiers received with each enhanced PLC signals, a physical position of a corresponding device 90, in respect to the physical locations of identified repeaters 95.

At least one device 90 may further comprise a communication unit 132 in wireless communication via a communication link 99 with control unit 110, with other devices 90, or with a communication unit 133 operating as a network bridge, and having an identifier and a physical location, which may be used similarly to those of repeaters 95. Control unit 110 and device 90 may be arranged to communicate through various communication links 99, and are not limited to PLC communication.

Communication unit 132 is arranged to send the data relating to the current measurements from device 90 for communication to control unit 110 (either directly or via PLC unit 124 of communication unit 133. Communication unit 132 thus enables extending the described system 100 to monitor devices 90 that are not directly connected to power line 96.

Device operation characteristics may comprise an update status of software installed on device 90. Control unit 110 may be arranged to derive the update status by detecting a predefined pattern of current consumption associated with the software update, for example alternately turning on and off a current consuming component in device 90, such as a display, loudspeakers, a modem, solenoids, heating elements or motors (e.g. servo motors). These features allows control unit 110 to supervise the software update status of all devices in the network.

Device 90 may comprise an encoder 126, arranged to encode specified device parameters into an operational sequence of device components, to yield an specified pattern of current measurements (e.g. a sequence of high and low current consumption periods). Control unit 110 may comprise a decoder 112 arranged to derive the specified device parameters from the received specified pattern of current measurements. Such a coding allow communicating messages between device 90 and control unit 110 on the basis if system 100, without addition of a dedicated communication system.

In embodiments, device 90 with a low current consumption, or device 90 that is sensitive to re-occurring current consuming operations, may cause (e.g. via PLC or communication link 99) another device to encode the message with its own current consumption, including a signal denoting the sender of the message as the relevant device 90.

Encoding messages by current consumption patterns allows control unit 110 call for data from devices 90 (data such as software update status), and enables devices 90 respond only by changing their current consumption according to a predefined code (e.g. a Morse code).

Furthermore, control unit 110 may prevent power supply to devices 90 that have not responded, or report devices 90 which were not updates, and system 100 thus allows efficient monitoring not only of the operational states of devices 90, but also of software parameters and other data which do not reflect in current consumption.

Elements such as encoder 126, communication unit 132 and processor 128 may be integrated within devices 90 or connected to devices 90 internally or externally.

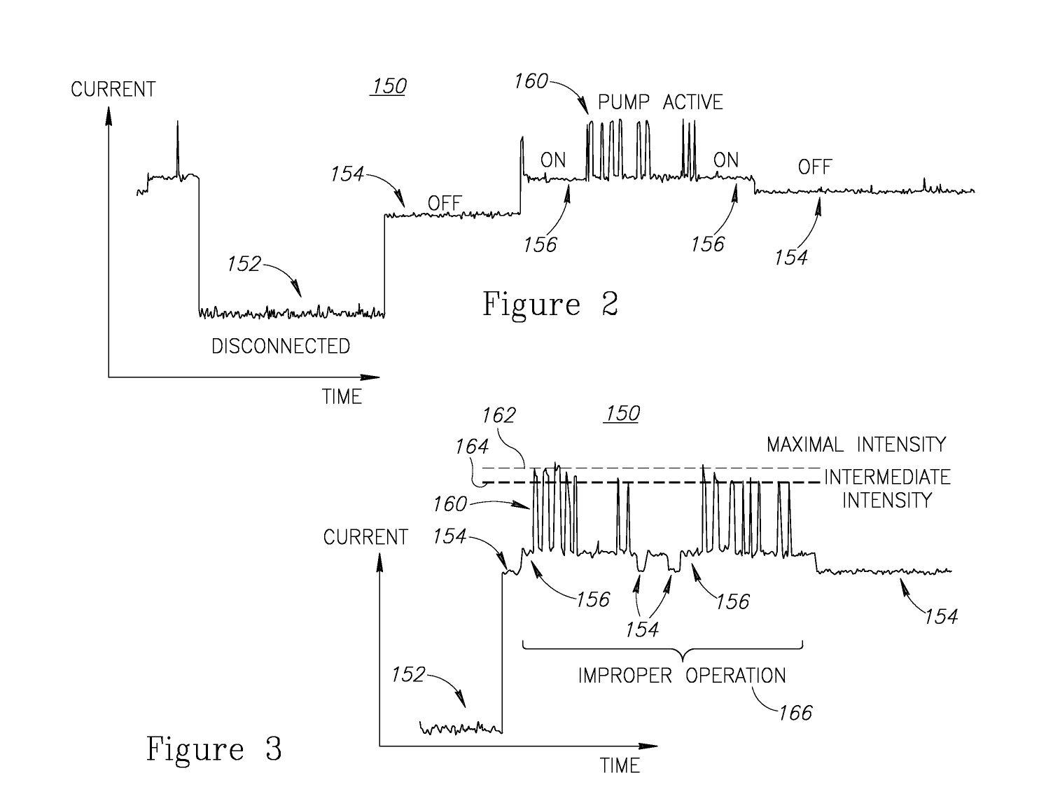

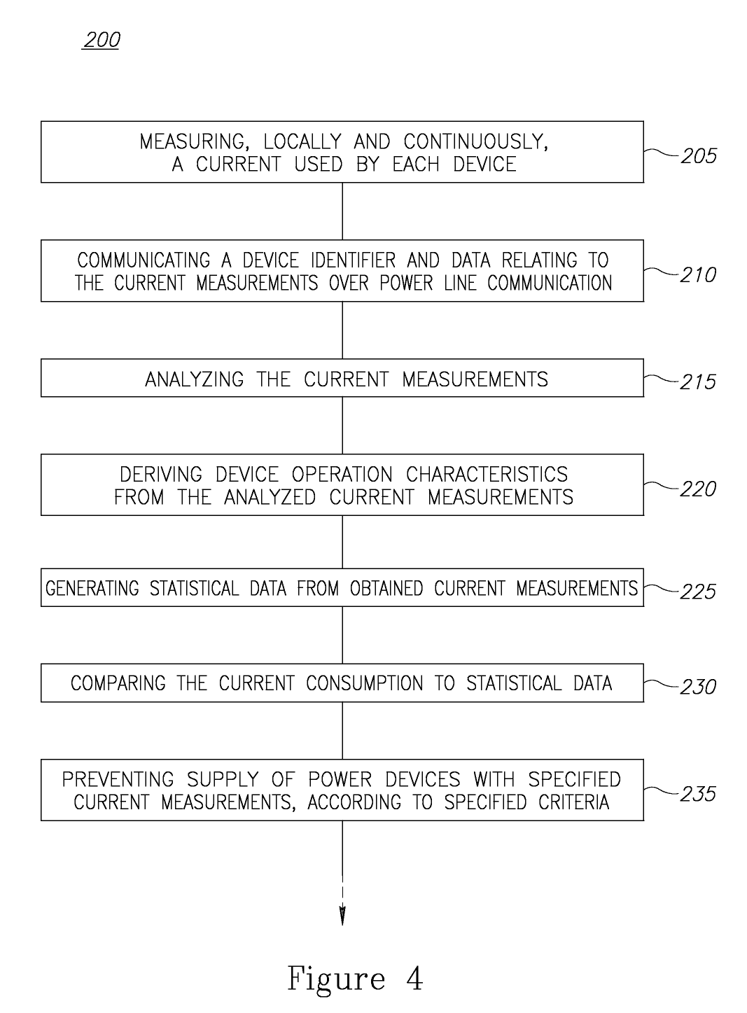

FIGS. 2 and 3 are examples 150 for current measurements and the information derived from them, according to some embodiments of the invention. Examples 150 are experimental results that relate to device 90 having a pump, such as an infusion or dialysis device. Examples 150 depict current measurements by current meter 122 along time.

Example 150 in FIG. 2 illustrates the differences in current consumption in various states of device 90: disconnection (152), connection and device turned off (154), device turned on (156) and operation of the pump (160). Data sent to control unit 110 may comprise all or some of the measurement, averaged measurements, or device states themselves as analyzed by processor 128.

Example 150 in FIG. 3 illustrates the detection of improper operation of device 90, identified upon a sequence of turning device 90 on (152) and off (154), and alternating operation of the pump (160) at maximal (162) and intermediate (164) intensities. This type of sequences may be identified by control unit 110 as indicating improper operation of device 90, and may be followed by preventing power supply to device 90, checking the problem, teaching the user how to properly operate device 90, etc.

The clear differences in measured current in different operational states of device 90 also allow communicating various short messages from device 90 to control unit 110, using current measurements to encode predefined parameters, such as software update versions. By operating device 90 in a specified operation pattern of current consuming components, short messages may be identified by decoder 112 in control unit 110.

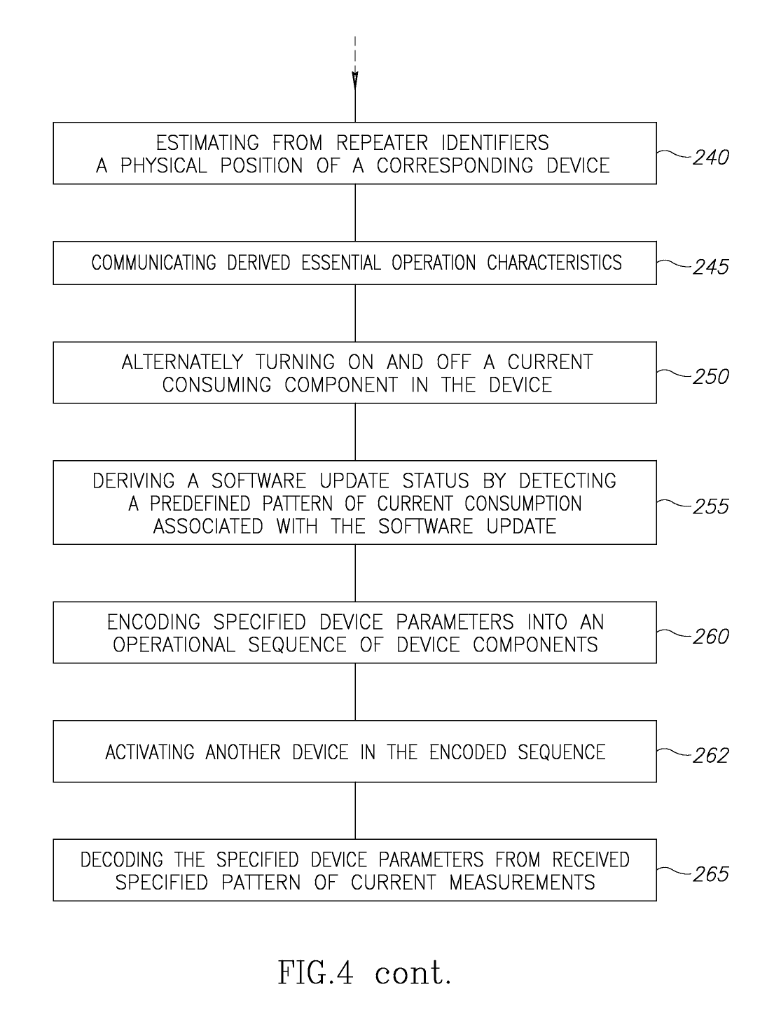

FIG. 4 is a high level flowchart illustrating a method 200 of monitoring devices 90 according to some embodiments of the invention. Method 200 may comprise the following stages: measuring, locally and continuously, a current used by each device (stage 205), communicating a device identifier and data relating to the current measurements over power line communication (PLC) (stage 210), analyzing the current measurements (stage 215) and deriving device operation characteristics from the analyzed current measurements (stage 220), e.g. to reduce a PLC communication volume. Only derived essential operation characteristics may be communicated (stage 245) to use the available bandwidth economically. At least one of stages 215 and 220 is carried out by at least one processor.

Method 200 may further comprise generating statistical data from obtained current measurements (stage 225) and comparing the current consumption to statistical data (stage 230), to yield device operational parameters.

Method 200 may further comprise preventing supply of power to at least one of the devices upon receiving specified current measurements, according to specified criteria (stage 235) relating e.g. to proper operation patterns or to authorized actions in relation to device users.

Method 200 may further comprise using repeater to enhance the PLC signals and estimating from repeater identifiers received with repeater-enhanced PLC signals, a physical position of a corresponding device, in respect to the physical locations of the identified repeaters (stage 240).

Method 200 may further comprise encoding specified device parameters into an operational sequence of device components (stage 260), to yield an specified pattern of current measurements, and deriving the specified device parameters from the received specified pattern of current measurements (stage 265). Encoding (stage 260) may comprise alternately turning on and off a current consuming component in the device (stage 250) or in another device. Encoding 260 may utilize any code, for example a Morse code. The specified device parameters may comprise a software update status, and deriving (stage 265) may comprise deriving a software update status by detecting a predefined pattern of current consumption associated with the software update (stage 255). Method 200 thus allows a control unit call for data from the devices (such as software update status), and enables the devices respond only by changing their current consumption according to a predefined code.

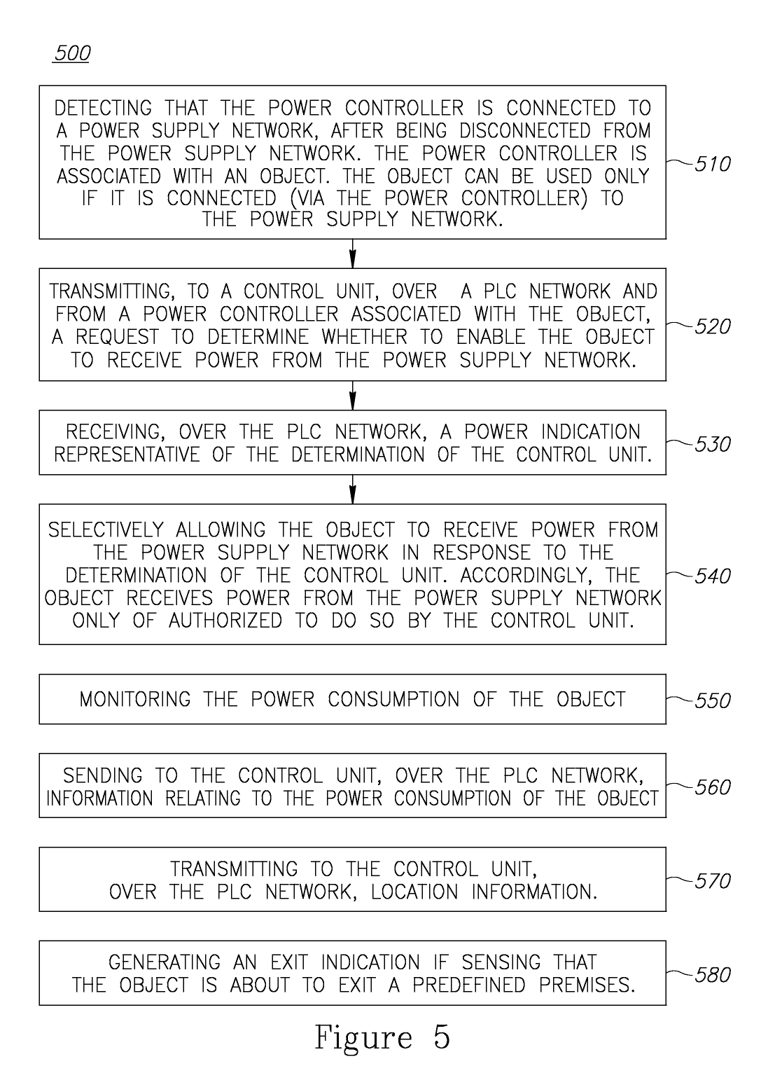

FIG. 5 illustrates method 500 for controlling a usage of objects, according to an embodiment of the invention. Method 500 may be implemented by a power controller such as current meter 122 and PLC unit 124.

Method 500 starts by stage 510 of detecting that the power controller is connected to a power supply network, after being disconnected from the power supply network. The power controller is associated with an object such as device 90. The object can be used only if it is connected (via the power controller) to the power supply network.

Stage 510 is followed by stage 520 of transmitting, to a control unit, over a PLC network and from a power controller associated with the object, a request to determine whether to enable the object to receive power from the power supply network.

Stage 520 is followed by stage 530 of receiving, over the PLC network, a power indication representative of the determination of the control unit.

Stage 530 is followed by stage 540 of selectively providing power to the object in response to the determination of control unit 110. Accordingly, the object received power from the power supply network only of authorized to do so by control unit 110.

Method 500 can include at least one of the following optional stages or a combination thereof: (i) stage 550 of monitoring the power consumption of the object; (ii) stage 560 of sending to control unit 110, over the PLC network, information relating to the power consumption of the object; (iii) stage 570 of transmitting to control unit 110, over the PLC network, location information, and (iv) stage 580 of generating an exit indication if sensing that the object is about to exit a predefined premises.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for monitoring a plurality of devices, comprising:
a control unit; and
associated with each device:
a current meter arranged to measure a current used by the device; and
a PLC unit arranged to send a device identifier and data relating to the current measurements to the control unit over power line communication (PLC),
wherein the control unit is arranged to analyze the current measurements and derive device operation characteristics therefrom.

2. The system of claim 1, wherein the device operation characteristics comprise a current consumption profile of each device.

3. The system of claim 2, wherein the control unit is arranged to derive, by comparing the current consumption to statistical data, at least one of the device operation characteristics: a device type, an operational state of the device, a deterioration in device operation, a device malfunction, an improper operation of the device, a loading status of the device, and an cumulative usage time of the device.

4. The system of claim 3, wherein the control unit is further arranged to generate the statistical data from obtained current measurements.

5. The system of claim 1, wherein the control unit is arranged to prevent supply of power to at least one of the devices upon receiving specified current measurements, according to specified criteria.

6. The system of claim 1, further comprising a plurality of repeaters arranged to enhance PLC signals from the PLC units to the control unit, each repeater having an identifier and a physical location, wherein each repeater is arranged to add to the enhanced PLC signals its identifier, and wherein the control unit is further arranged to estimate from the repeater identifiers received with each enhanced PLC signals, a physical position of a corresponding device, in respect to the physical locations of the identified repeaters.

7. The system of claim 1, wherein at least one of the devices further comprises a communication unit in wireless communication with the PLC unit, arranged to send the data relating to the current measurements obtained therefrom to the control unit.

8. The system of claim 1, further comprising a communication unit having a PLC unit and arranged to receive data from at least one of the devices over a communication link and transmit the received data to the control unit over PLC.

9. The system of claim 1, wherein at least one of the devices further comprises a processor arranged to derive the data relating to the current measurements from the current measurements to comprise operation relevant data, and wherein the data relating to the current measurements requires a PLC bandwidth smaller than half a PLC bandwidth required by the current measurements, selected to allow communication of the data over PLC during a specified threshold period.

10. The system of claim 9, wherein the operation relevant data comprises at least one of: current idle consumption, current peaks, current drops, and current derivatives.

11. The system of claim 1, wherein the device operation characteristics comprise an update status of software installed on the device, and wherein the control unit is arranged to derive the update status by detecting a predefined pattern of current consumption associated with the software update.

12. The system of claim 11, wherein the predefined pattern of current consumption comprises alternately turning on and off a component in the device that consumes a current detectable by the current meter.

13. The system of claim 1, wherein at least one device comprises an encoder, arranged to encode specified device parameters into an operational sequence of device components, to yield an specified pattern of current measurements, and wherein the control unit comprises a decoder, arranged to derive the specified device parameters from the received specified pattern of current measurements.

14. A method of monitoring a plurality of devices, comprising:
measuring, locally and continuously, a current used by each device;
communicating a device identifier and data relating to the current measurements over power line communication (PLC);
analyzing the current measurements; and
deriving device operation characteristics from the analyzed current measurements,
wherein at least one of the analyzing and the deriving is carried out by at least one processor.

15. The method of claim 14, further comprising:
generating statistical data from obtained current measurements; and
comparing the analyzed current measurements to the statistical data, to yield device operational parameters.

16. The method of claim 14, further comprising preventing supply of power to at least one of the devices upon receiving specified current measurements, according to specified criteria.

17. The method of claim 14, further comprising estimating from repeater identifiers received with repeater-enhanced PLC signals, a physical position of a corresponding device, in respect to the physical locations of the identified repeaters.

18. The method of claim 14, further comprising deriving the data relating to the current measurements from the current measurements, to reduce a communication volume.

19. The method of claim 14, further comprising:
encoding specified device parameters into an operational sequence of device components, to yield an specified pattern of current measurements, and
deriving the specified device parameters from the received specified pattern of current measurements.

20. The method of claim 19, wherein the encoding comprises alternately turning on and off a component in the device that consumes a current detectable by the current meter.
